(19) United States
(12) Patent Application Publication
(10) Pub. No.: US 2014/0069971 A1
(43) Pub. Date: Mar. 13, 2014

(54) Roof Rack Mounting System

(71) Applicant: Andrew van Kaathoven, Huntingdale (AU)

(72) Inventor: Andrew van Kaathoven, Huntingdale (AU)

(21) Appl. No.: 14/019,171

(22) Filed: Sep. 5, 2013

(30) Foreign Application Priority Data
Sep. 7, 2012 (AU) 2012903920

(51) Int. Cl. B60R 9/058; B60R 9/052

(52) U.S. Cl. CPC B60R 9/058; B60R 9/052
USPC 224/329

(57) ABSTRACT

A roof rack mounting and weight transfer system for vehicles with removable hard tops, the system including at least two mounting arrangements, each mounting arrangement including an external support mount that is secured to the external surface of the roof for attaching a roof rack to, and internal transfer means to transfer the load from the support mount to the vehicle body or frame.

### FIELD OF THE INVENTION

The present invention relates to mounting systems forming a roof rack to a vehicle with a removable hard top.

### BACKGROUND OF THE INVENTION

Vehicles with removable hard tops, such as a Jeep JK Wrangler, can make the mounting of roof racks quite difficult.

Many vehicles have permanently affixed roof rails that run from the front to the back of the roof. Feet can attach to these rails and then cross beams are attached across the roof. The disadvantage of permanently installed roof rails is that they prevent a forklift from inserting their tines between cross beams to load and unload payload from the roof rack. Another disadvantage is that the load is taken by the roof, resulting in the load able to be carried by the roof rack being relatively small. Such attachment is not suitable for a removable hard top, as the roof alone is unable to carry a weight greater than 30 kg. A roof rail system would not be capable of carrying weight in excess of 100 kg.

Other roof rack systems may have feet that attach directly into the roof. Again, such a system does not allow for the carrying of weight in excess of 100 kg.

Those systems that can carry in excess of 100 kg have roof rails that run the full length of the roof, and some versions have an external frame that comes down the outside of the A-pillar and D-pillar. Such systems require their full removal before any element of the hard top can be removed.

It is a desired object of the present invention to provide an alternative roof rack mounting system that is suitable for vehicles with removable hard tops.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

According to a first aspect, the present invention provides a roof rack mounting and weight transfer system for vehicles with removable hard tops, the system including:

at least two mounting arrangements, each mounting arrangement including:
an external support mount that is secured to the external surface of the roof for attaching a roof rack to; and
internal transfer means to transfer the load from the support mount to the vehicle body or frame.

Preferably, the system is such that the hard top can be removed without having to disconnect any element of the system from the component of the roof or vehicle to which it is fastened.

Advantageously, when the system is installed, the hard top can be removed without having to remove any hardware additional to the original hardware provided for the hard top by the vehicle manufacturer.

According, to a preferred embodiment, the freedom panel can be removed whilst the roof rack is in use.

Preferably, the system includes a pair of front mounting arrangements and a pair of rear mounting arrangements.

According to a second aspect, the present invention provides a roof rack mounting and weight transfer system for vehicles, the system including:

at least two front mounting arrangements and at least two rear mounting arrangements, each mounting arrangement including:
an external support mount that is secured to the external surface of the roof for attaching a roof rack foot to; and
internal transfer means to transfer the load from the support mount to the vehicle body or frame;

wherein the external support mounts are such that between installed roof rack rails running across the roof, an unobstructed area is provided on top of the hard top such that the tines of a fork lift can be inserted to place a load onto the roof rack or to remove a load off the roof rack.

Advantageously, a roof rack installed with the mounting system increases the carrying capacity of the removable hard top to in excess of 100 kg.

Preferably, the vehicle has a body-on-frame construction. In a preferred embodiment, the vehicle is a Jeep Wrangler.

The front mounting arrangements are positioned to preferably transfer load through the frame of the vehicle. The frame preferably includes a roll bar that integrates into the B-pillar that runs into the floor. The load is preferably transferred through the B-pillar.

The front mounting arrangements' internal transfer means preferably include a weight transfer bracket that is attached to the vehicle's frame.

The rear mounting arrangements internal transfer means preferably include an internal frame including at least two columns that transfer load down to the vehicle body.

The external support mounts may have an internal surface that matches the external profile of the roof or hard top, and preferably sit on top of the roof or hard top with a bottom edge in the roof channel, advantageously allowing the support mounts' upper surface to self level.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

The invention will now be described, by way of example only with reference to the accompanying drawings, in which:

FIG. 1 is a perspective view of a vehicle with a removable hard top with a roof rack mounting and weight transfer system installed;

FIG. 2 is a front perspective view of the system of FIG. 1 with the roof racks installed;

FIG. 3 is a perspective view of the vehicle of FIG. 2 with roof racks loaded;

FIG. 4 is a perspective rear view of removable hard top being removed from the vehicle with the system installed;

FIG. 5 is a front view of all of the components of the system;

FIG. 6 is a side view of a vehicle showing the positioning of a front mounting arrangement;

FIG. 6a is a cross-sectional rear view of the front mounting arrangement of FIG. 6;

FIG. 7 is an exploded cross-section rear view of the mounting arrangement of FIG. 6a;

FIG. 8 is a front top view of the vehicle frame adjacent the B-pillar;

FIG. 9 is a rear top view of a front internal transfer means positioned on the frame of FIG. 8;

FIG. 10 is view similar to FIG. 9 with fasteners securing the internal transfer means;

FIG. 11 is a side view of a weight transfer bracket of the internal transfer means of FIG. 10;

FIG. 12 is a rear view of the weight transfer bracket of FIG. 11 installed;

FIG. 13 is a side view from inside the cargo space of the vehicle with the roof being removed

FIG. 14 is a close up view of the alignment tabs on the inside of the rear roof section;

FIG. 15 is a side view of a vehicle showing the positioning of a rear mounting arrangement;

FIG. 15a is an exploded cross-section rear view of the mounting arrangement of FIG. 5;

FIG. 16 is a cross-sectional rear view of the mounting arrangement of FIG. 15a;

FIG. 17 is a side view from inside the cargo space showing the internal transfer means of a rear mounting arrangement; and

FIG. 18 is a close up view of a section of the internal transfer means of FIG. 17.

### DETAILED DESCRIPTION F THE EMBODIMENTS

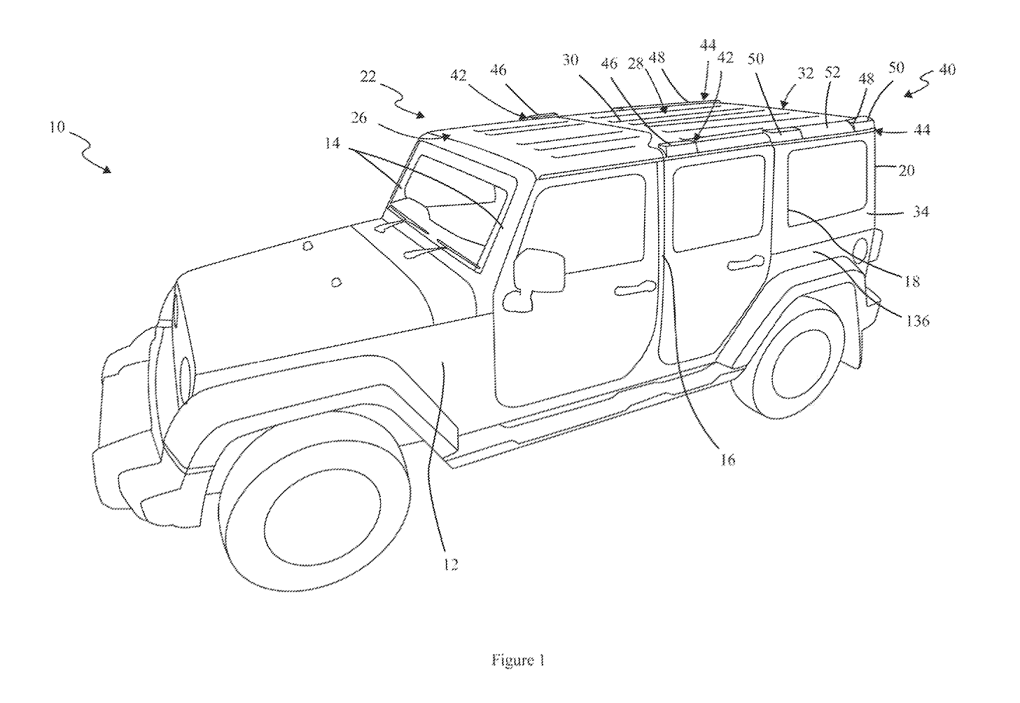

A Jeep JK Wrangler is shown in FIG. 1 that has a body-on-frame construction, which is a vehicle that has a full structural frame that the engine, transmission and all suspension components are attached to. The body and bed are separate components that are bolted on top of the frame. It will be appreciated that the present invention may be adapted to suit different vehicle constructions.

This vehicle 10 has a body 12, with pairs of A-pillars 14 and B-pillars 16 that extend from the roof 22 to the vehicle floor. The roof 22 illustrated is a modular removable hard top that includes a front freedom section 26 that can be separately removed to the rear section 28. The rear section 28 includes a front 30 and a rear 32, with the rear 32 having wall sections 34 with the C-pillars 18 and D-pillars 20 and windows for enclosing, the cargo area 36.

In the embodiments illustrated, the freedom section 26 does not include any mounting arrangements; however it will be appreciated that such an arrangement could be provided in accordance with the invention. The rear section 28 has a roof rack mounting and weight transfer system 40 installed, having two front mounting arrangements 42, one on either side of the roof, and two rear mounting arrangements 44, one on either side of the roof. As can be seen in FIG. 1, the mounting arrangements 42, 44 include external support mounts 46, 48 that are shaped to be unobtrusive to the visual appearance of the vehicle, such that they can be maintained in a permanently installed position on the roof.

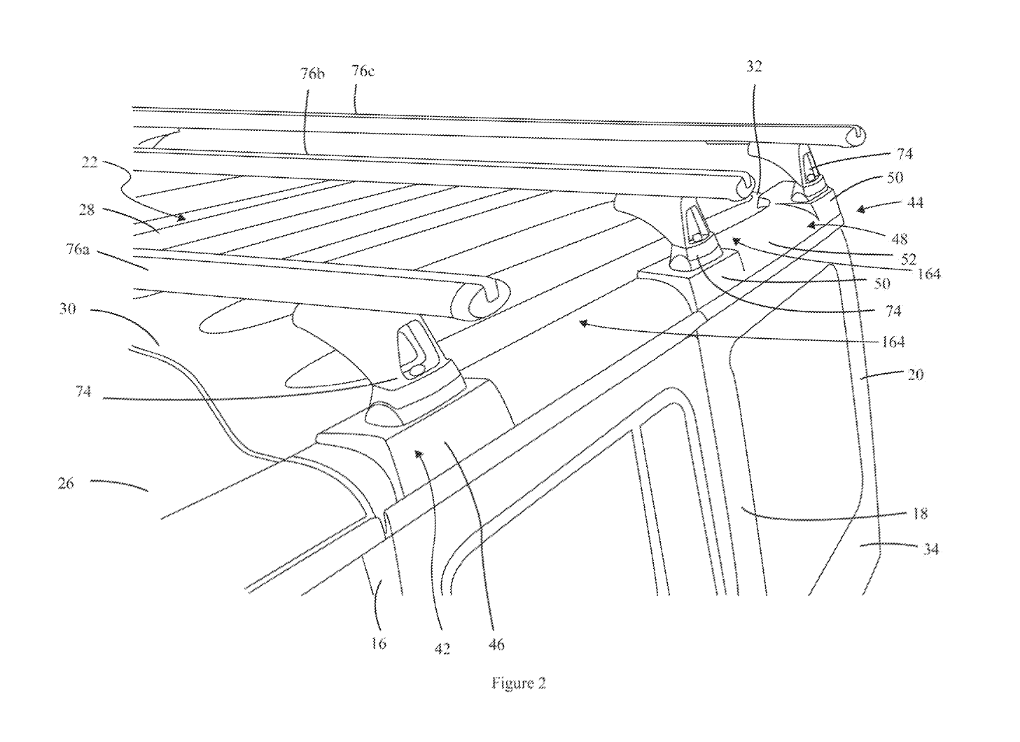

The front external support mounts 46 are approximately 200 mm in length and are positioned at the front 30 close to the B-pillar 16. The rear external support mounts 48 are longer at approximately 900 mm and extend between the C-pillar 18 and the D-pillar 20, and have two toot mounting sections 50, with a contoured section 52 running therebetween that follows the curves of the roof line. As shown in FIG. 2, a roof rack cross beam 76a runs across the roof between two feet 74 that attach to the front external support mounts 46. Two cross beams 76b, 76c run across the roof between two feet 74 that attach to the foot mounting sections 50.

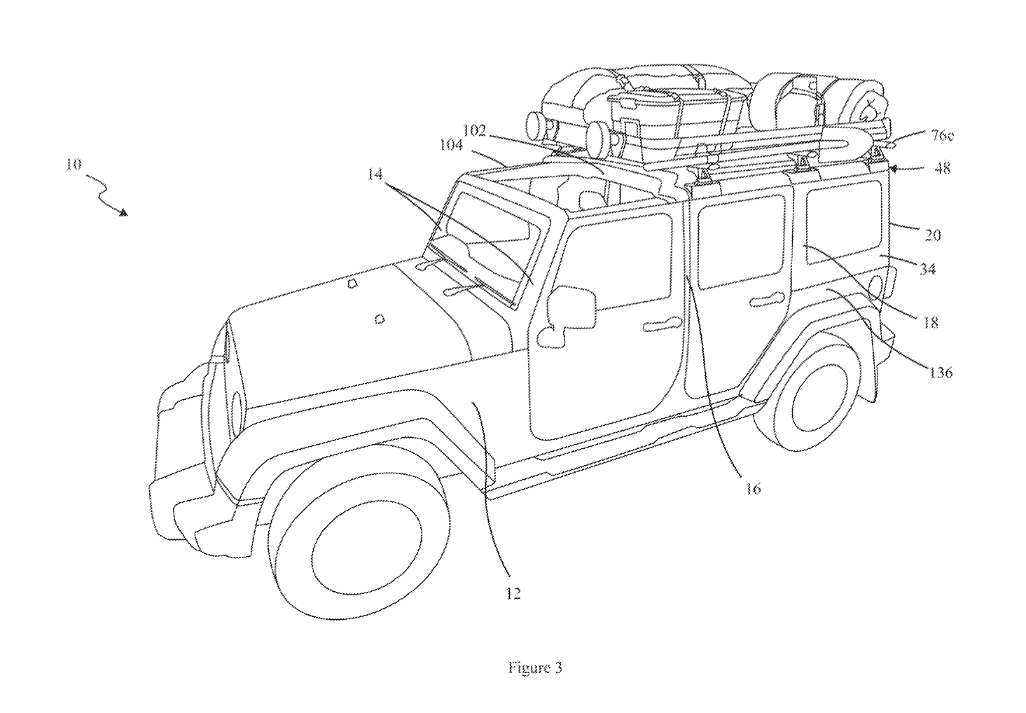

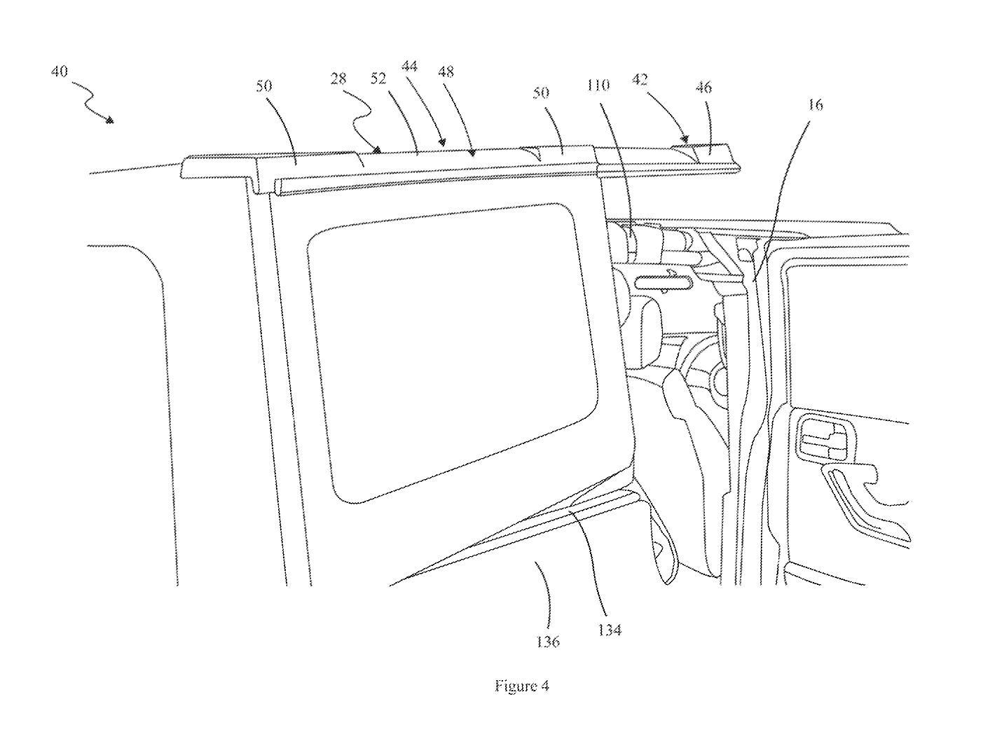

As can be seen from FIG. 3, the roof rack can be loaded and is separate to the freedom panel 26, such that the freedom panel 26 can he removed whilst the roof rack is in use. Further, as shown in FIG. 4, the rear section 28 of the roof can be removed whilst the roof rack mounting and weight transfer system 40 is fully installed. The roof rack rails 76 could also remain mounted to the system without preventing removal of the roof. Typically, a removable hard top roof 22 is secured to the vehicle by six fasteners in the rear cargo area and two at the front 30. Existing mounting systems require the removal of components of the system and additional fasteners before the roof can be removed. With the present invention, the roof can be removed without having to remove any hardware additional to the original hardware provided for the hard top by the vehicle manufacturer.

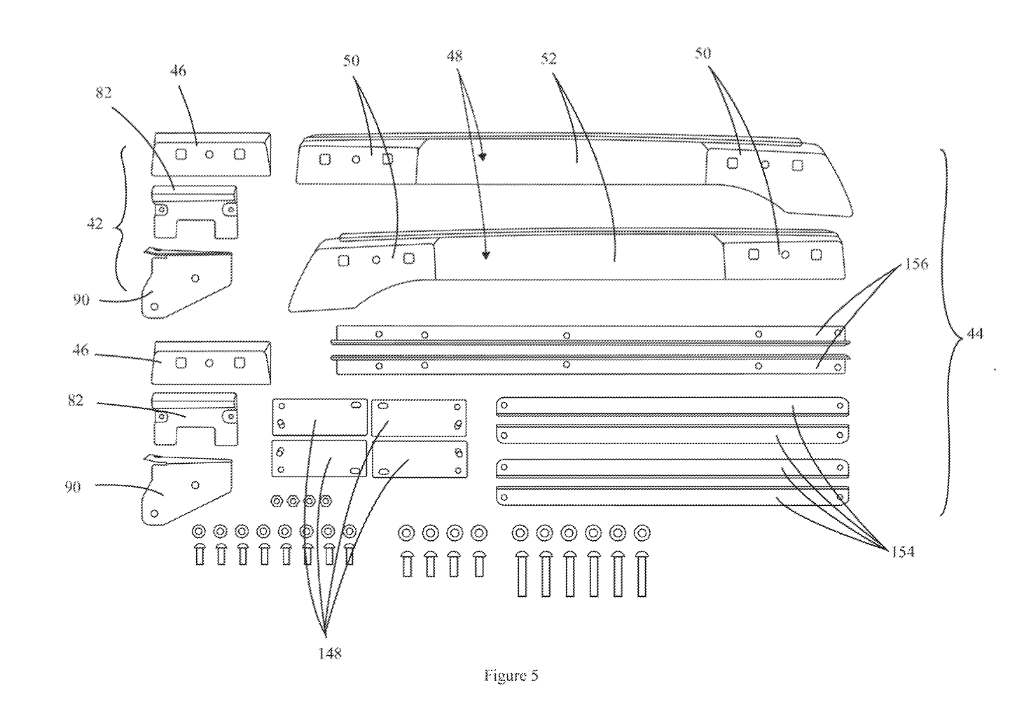

The components of the illustrated embodiment of the system 40 are shown in FIG. 5, with each of these components being discussed in detail below.

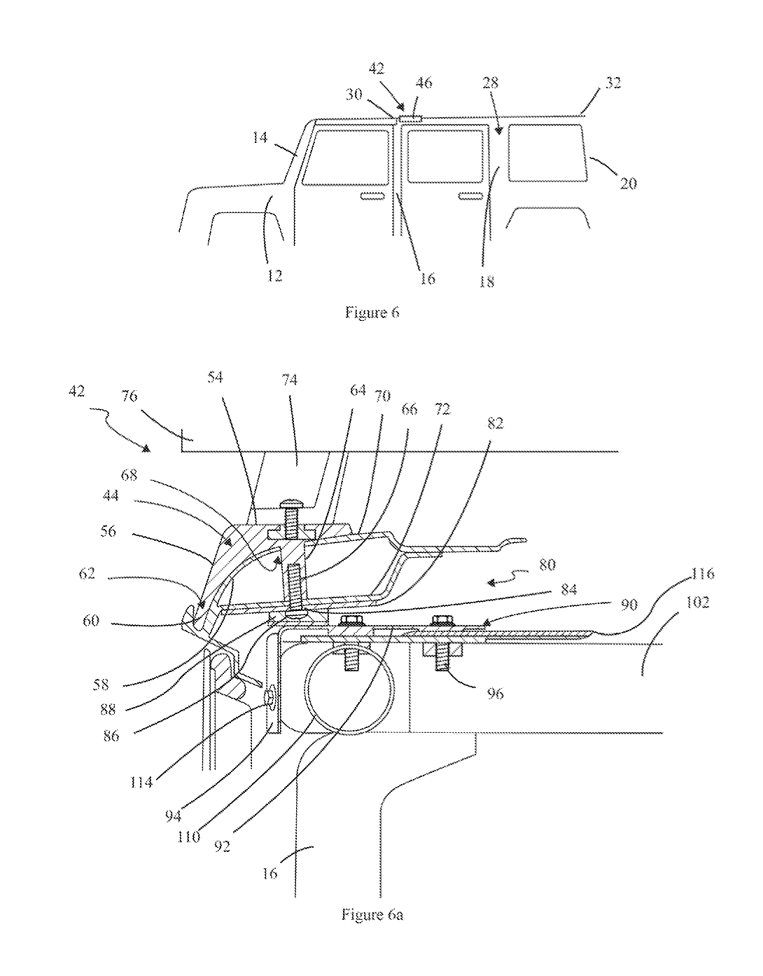

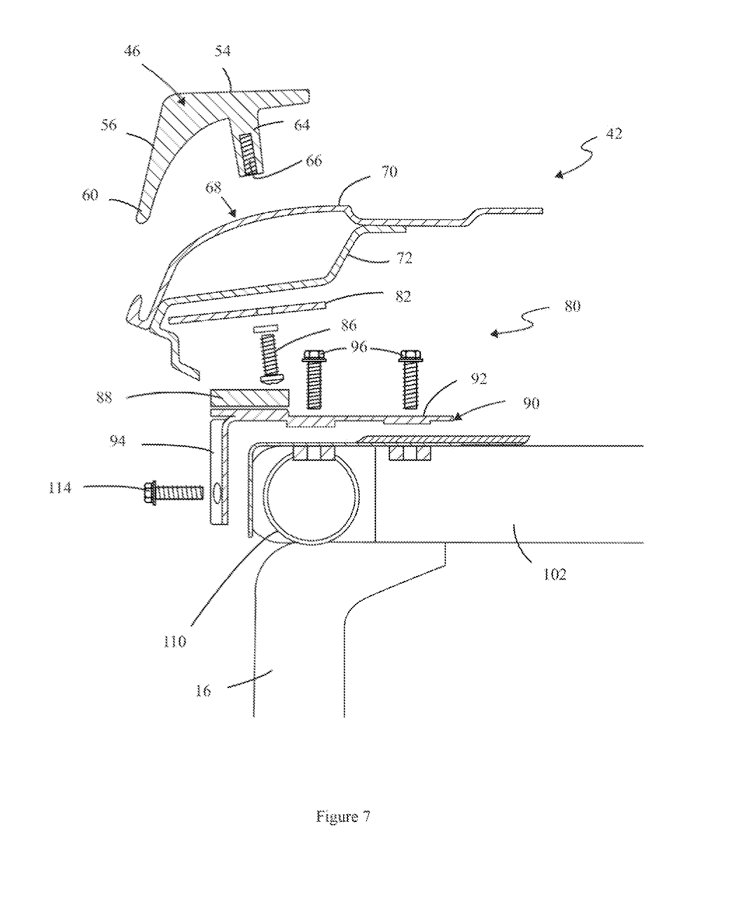

A front mounting arrangement 42 is shown in cross-section in FIG. 6a and shows the external support mount 46 that has upper and lower external surfaces 54, 56 and an internal surface 58. The internal. surface 58 is contoured to match the external profile of the roof 22, with the bottom edge 60 of the mount sitting within the roof channel 62. Two protrusions 64 with an internally thread shaft 66 extend from the internal surface in a direction perpendicular to the upper surface 54. The protrusions 64 are inserted into apertures 68 made in the top skin 70 of the roof 22 and are sized to abut against the inside of the lower skin 72 of the roof. This positioning allows the bottom edge 60 to lodge in the roof channel 62, self levelling the upper surface without manual adjustment. When all mounting arrangements are inserted in this way, it results in all of the upper surfaces being substantially horizontal, such that when the roof rack feet 74 are affixed, the cross bars 76 will be installed at an even height.

Front internal transfer means 80 are provided to transfer the load from the support mount 46 to the vehicle frame. In the front mounting arrangement 42, the internal transfer means 80 includes a plate 82 that sits on the underside of the roof 22 and includes apertures 84 for the insertion of screws 86 into the threaded shaft 72 of the support mount 46, clamping the roof 22 between the support mount 46 and the plate 82, with the protrusion ensuring that the fibreglass skins 70, 72 are not squeezed together, whilst creating a very secure attachment to the roof.

Without any additional mechanical attachment, the load from the roof racks is carried through the protrusions 64 and the head of the screw 86 to a weight transfer bracket 90 with an absorption pad 88 sitting between the screw 86 and the bracket 90 to reduce friction and associated noise. The roof 22 is attached to the vehicle body 12 using the standard manufacturer's fixtures. Due to this lack of additional connection, the roof can be removed without having to undo any of the mounting system hardware.

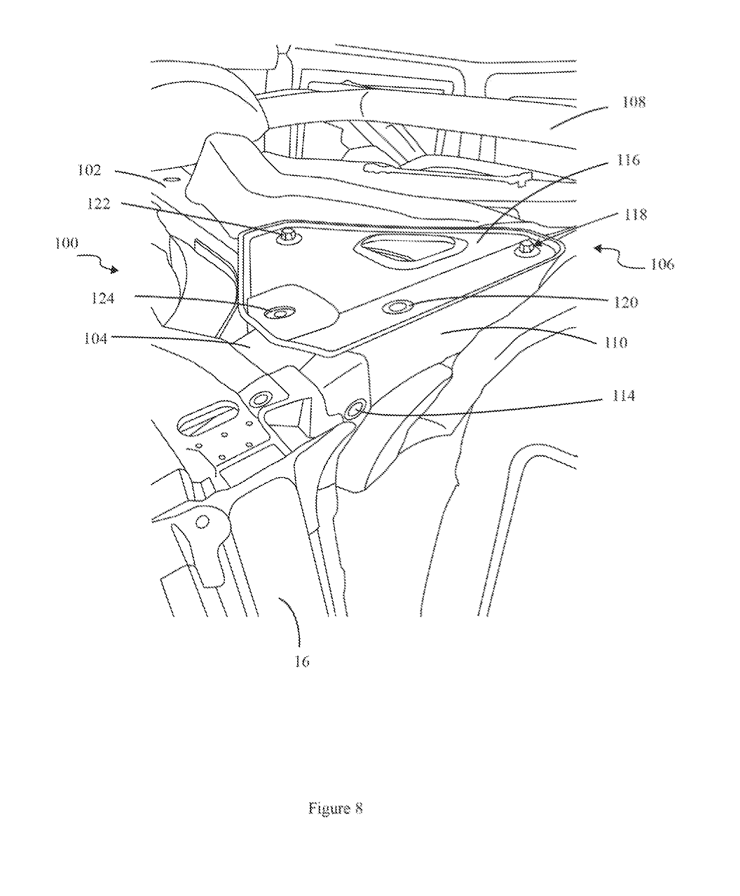

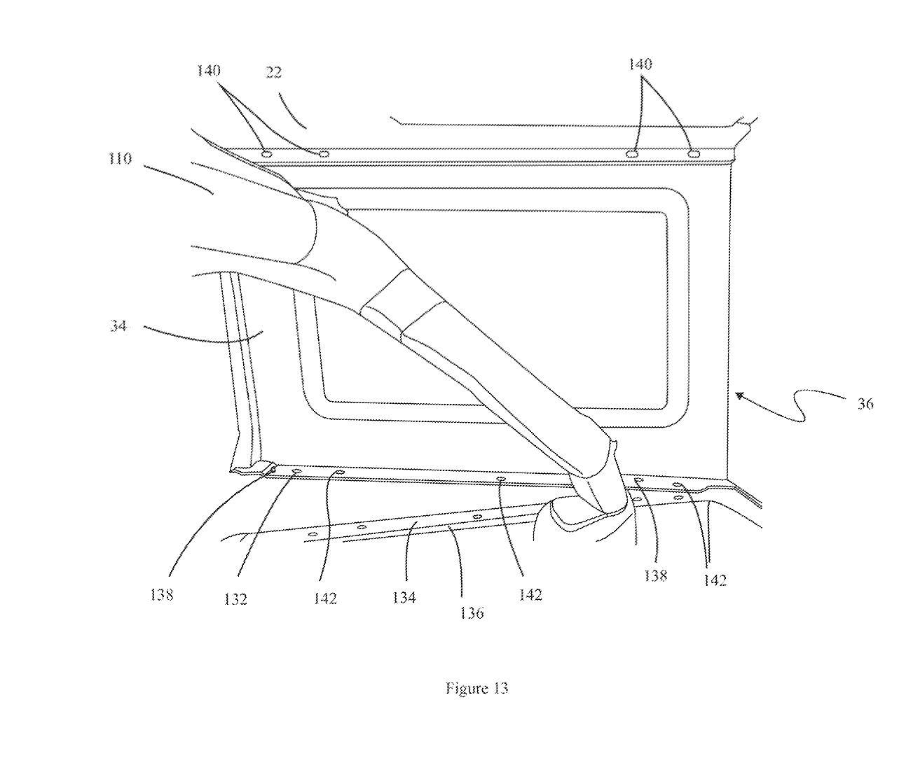

FIG. 8 shows a section of the vehicle frame without the system installed. The frame includes a front frame section 100 consisting of a central cross beam 102 that extends across the vehicle body. Projecting forward from the cross beam 102 are two front rails 104 that connect to the window shield frame (not shown) which creates the A-pillars 14. The rear frame section 106 includes the rear cross beam 108 and two side rails 110. The side rails 110 extend downwards at their rear to connect to the side walls 136 of the body in the cargo area (see FIG. 13). The side rails 110 at their front bend downwards to integrate into the B-pillar 16 and run into the floor. The B-pillar 16 (as shown in FIG. 8) creates an external frame into which the side rails 110 extend. A connection point 114 is shown in FIG. 8 connecting the B-pillar frame 16 to the side rail 110. A pair of top plates 116 are used to tie together the front frame section 110 to the rear frame section 106, by each having two attachment points 118, 120 on the rear side rail 110 and two further attachment points 122, 124, one on the cross beam 102 and one on the front rail 104.

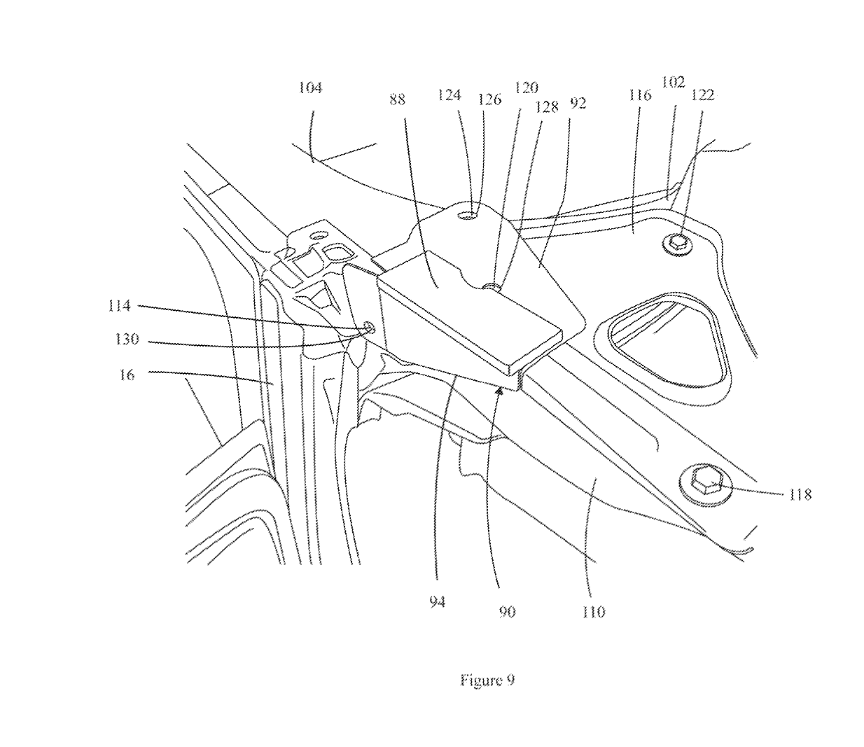

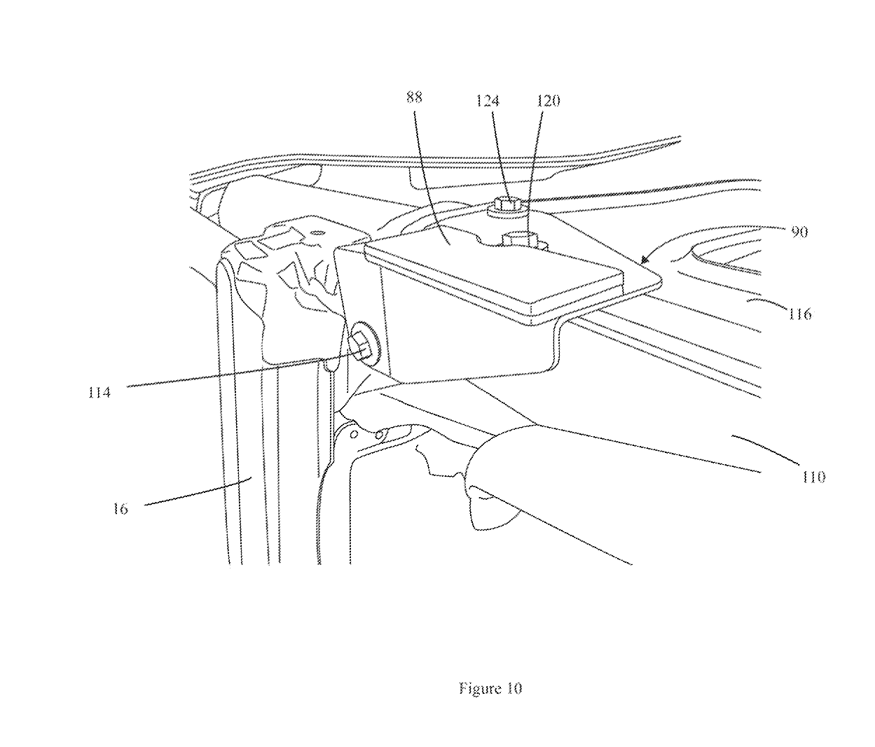

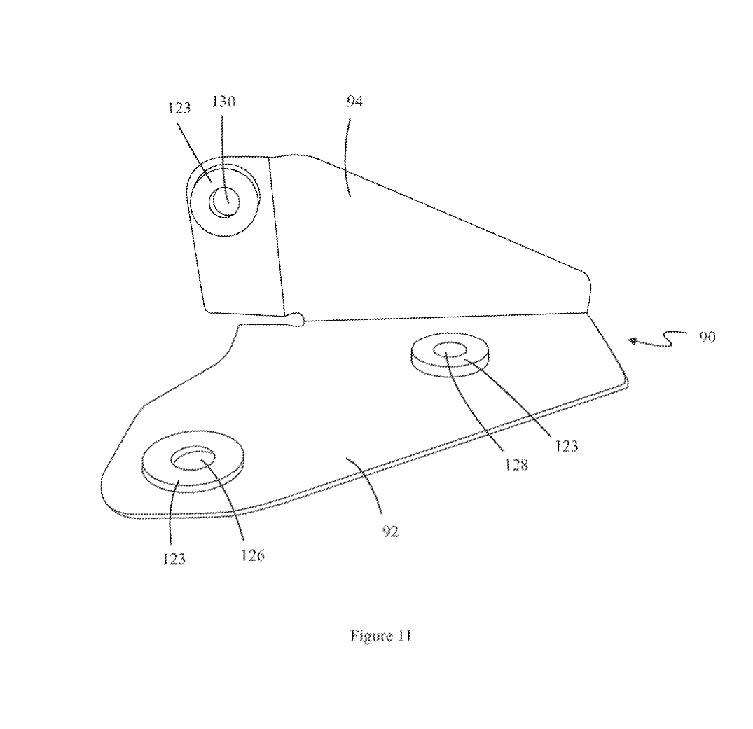

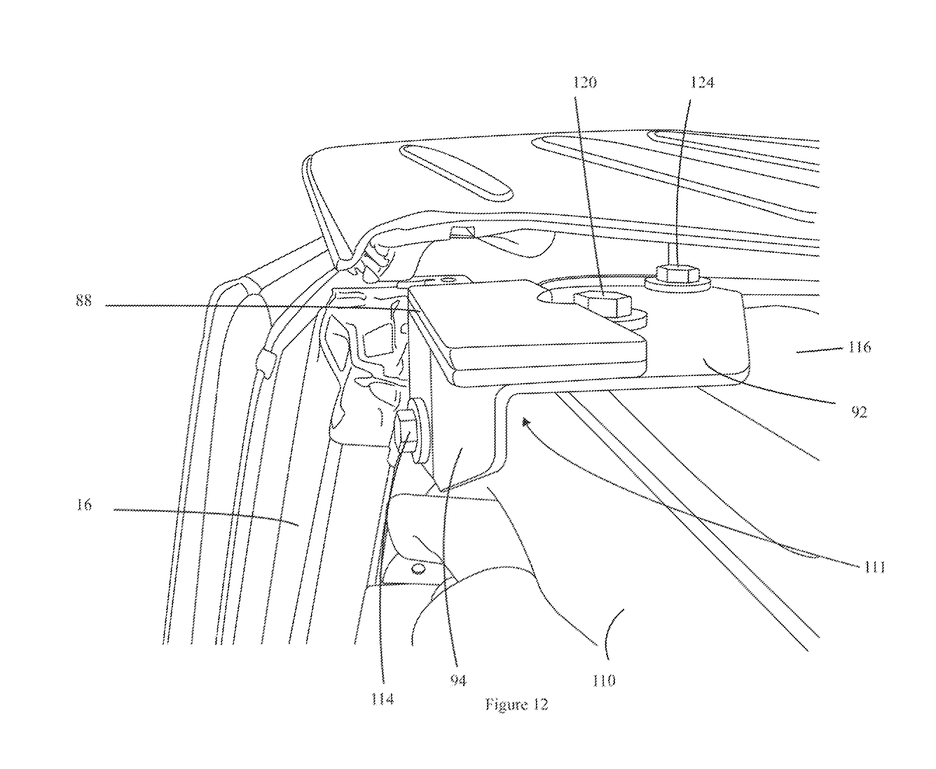

As shown in FIGS. 9 and 10, the weight transfer bracket 90 sits on top of the top plate 116. The weight transfer bracket 90 is a right angle bracket having a first plate section 92 and a second plate section 94 substantially perpendicular thereto. The first plate section 92 sits against the top plate 116 and the second plate section 94 sits against the side of the side rail 110 and B-pillar connection point 114, The inside of the bracket 90 is shown in FIG. 11, where integral washers 123 are formed at the apertures 126, 128, 130. Aperture 130 in the second plate section 94 aligns with the B-pillar connection point 114. Apertures 126, 128 in the first plate section 92 align respectively with the attachment points 124, 120 in the top plate 116. The washers 123 on the underside of the bracket 90 are different depths, for example 2 mm and 4 mm, so that the bracket 90 securely matches the upper side of the top plate 116, whilst keeping the bracket plate section 92, 94 in correct alignment to receive the load transferred from the external support mount 46. The side washer at aperture 130 has a greater depth in order to space the second plate section 94 outwardly offset from the edge of the side rail 110, as best shown in FIG. 12, where a gap 111 is created. By offsetting the bracket in this way, such that the first plate section 92 bangs over the edge of the top plate 116, the section of the first plate section 92 underlying the absorption pad is further towards the edge of the roof. The structure at the edge of the roof is stronger in the area where there is an internal skin 72 and an external skin 70, as shown in FIG. 6a. The bracket 90 takes the load through the absorption pad 88 and due to the offset location of the bracket, more of the load is taken down through the B-pillar 16 and less through the remainder of the front and rear frame sections 100, 106.

By aligning the bracket apertures 126, 128, 130 with the existing connection points 124, 120, 114, no modifications need to occur to the vehicle frame or body. All new apertures for fitting the system are made in the roof, which means that the roof could be replaced, with the brackets 90 removed, and the vehicle would be returned to its original condition. Many modifications made to these sorts of vehicles require the creation of new apertures in the frame or body, or the welding of new components to the original frame.

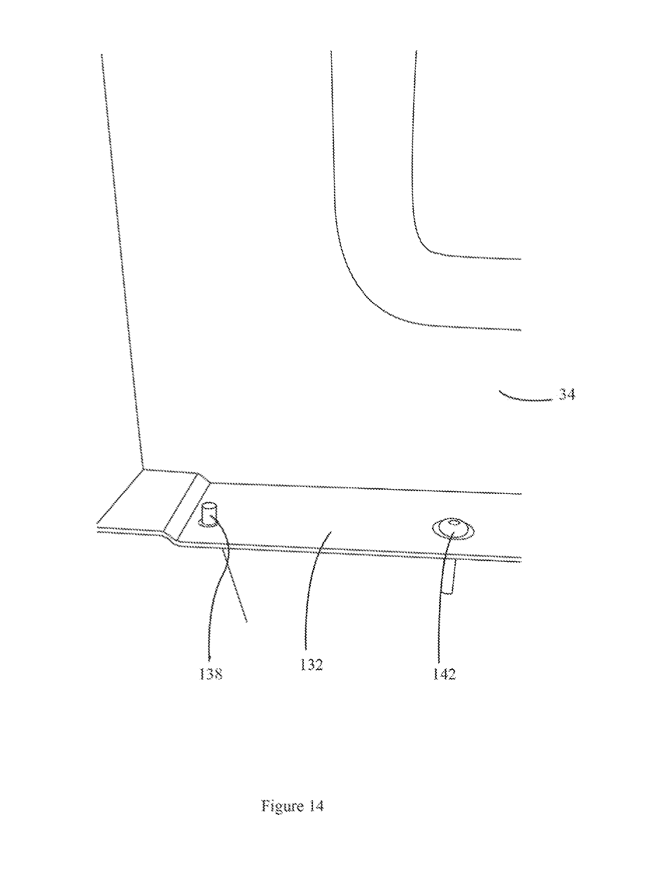

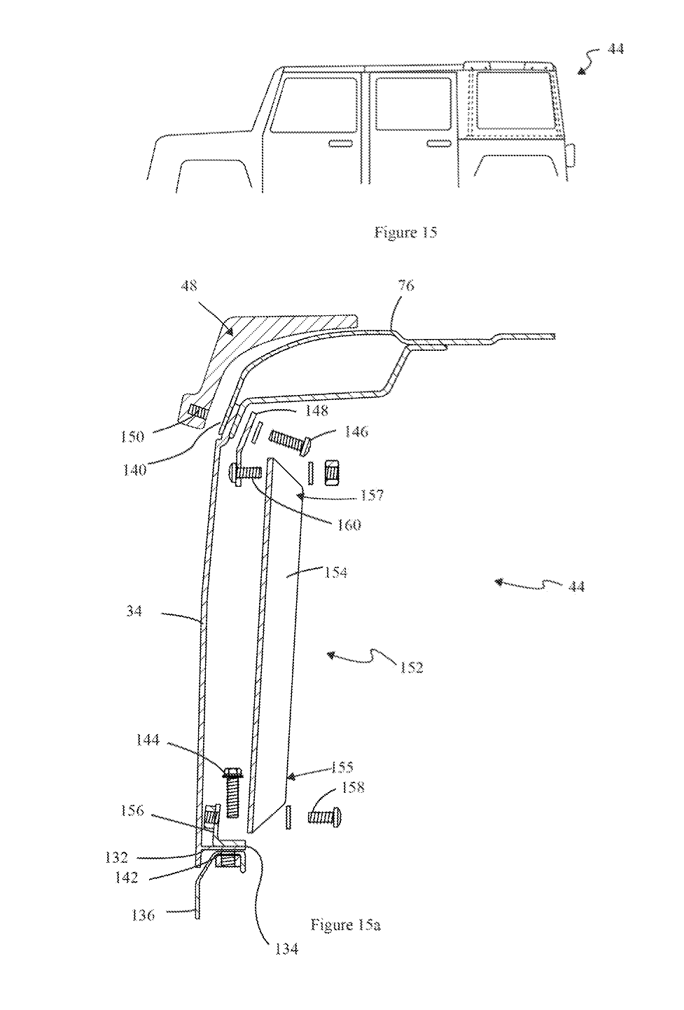

Turning to the rear mounting arrangements 44, FIGS. 13 and 14 show the internal side of the rear wall 34 of the roof 22. Underneath the window is an internally protecting flange 132 that sits atop the top surface 134 of the side wall 136 of the cargo area 36 when the roof is installed. On the flange 132 there are existing pins 138 that project upwardly.

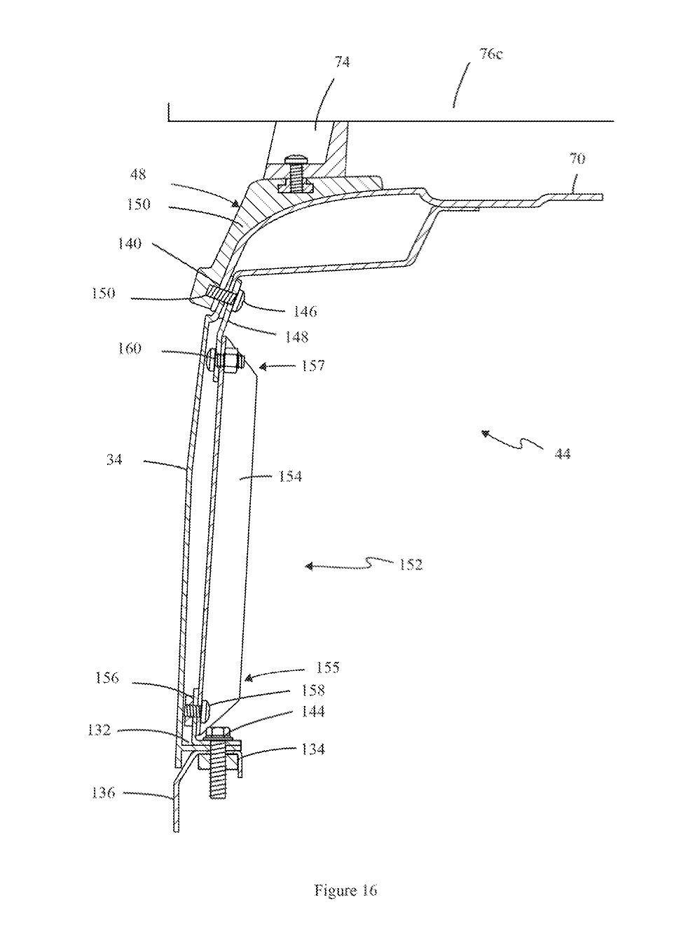

As can be seen in FIG. 13, the modifications required are made to the roof, with four apertures 140 being drilled through the wall 34 and the roof top skin 70. The projecting flange 132 also includes existing apertures 142 for the insertion of fasteners 144 to secure the roof 22 to the body of the vehicle at side wail 136. As shown in FIGS. 5a and 16, the rear mounting arrangement 44 includes an external support mount 48 that is secured directly to the outer roof skin 70, via fasteners 146 clamping the roof at two points between an inner plate 148 and the external support mount 48 that includes four corresponding threaded. shafts 150. The internal transfer means 152 includes the two internal plates 148 that are located, above and to the sides of the window at the top of the wall 34. Projecting downwards from each of the plates 148 are two columns 154, which are joined together at their lower ends 155 by a horizontal cross beam 156 to create an internal frame. The columns 154 and cross beam 156 are illustrated as L-shaped in cross-section, but it will be appreciated that any suitable profile may be used. The lower ends 155 of the columns 154 are fixed to the cross beam 156 by fasteners 158. The upper ends 157 of the columns 154 are fixed to the inner plate 148 with fasteners 160.

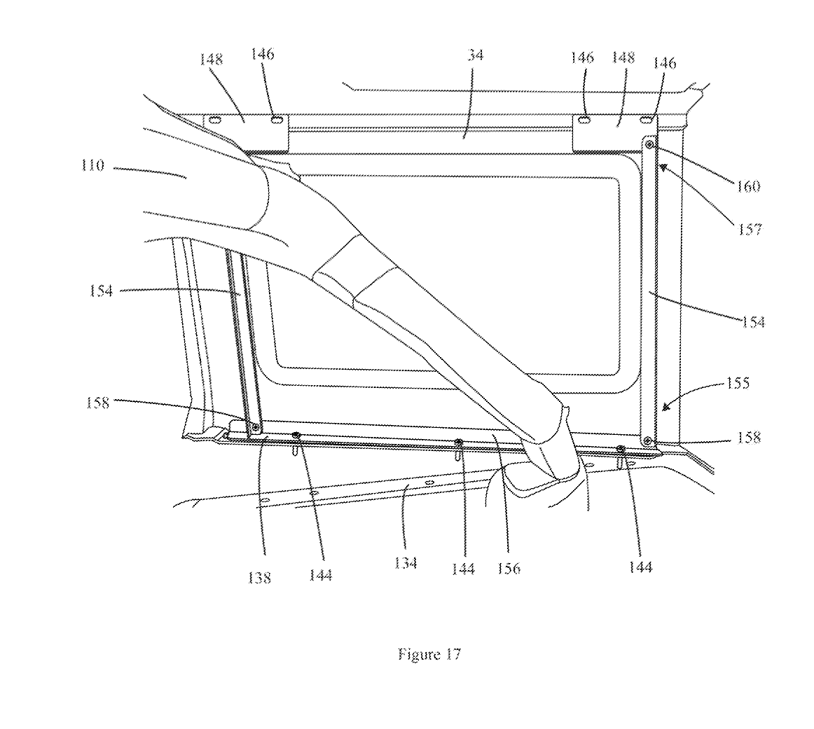

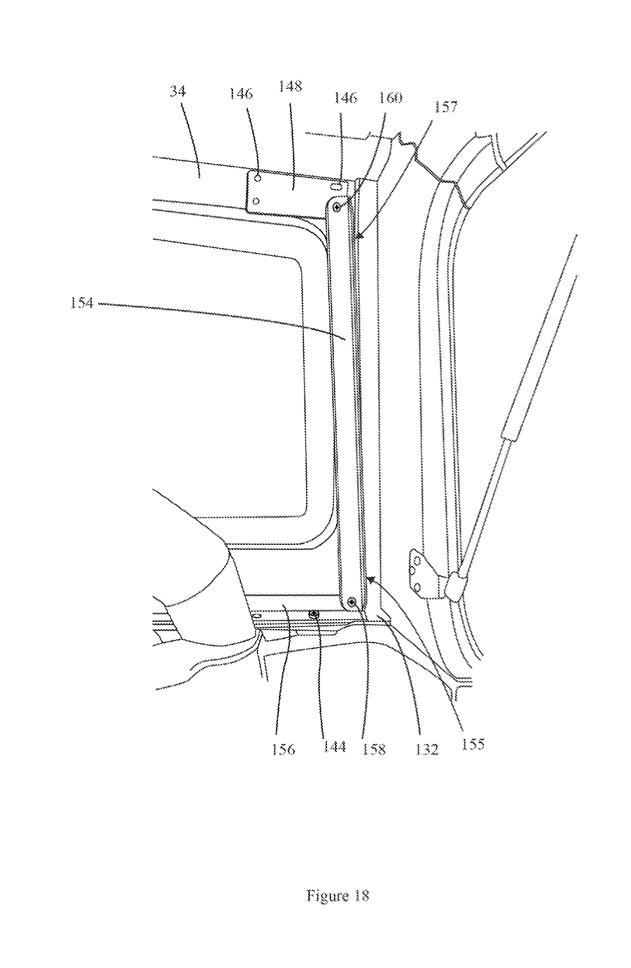

The horizontal cross beam 156 has apertures 162 that align with the apertures 142 in the flange 132 such that fasteners 144 simultaneously affix the cross beam 156 and the flange 132 to the top surface 134 of the side wall 136. The cross beam also includes apertures (not shown) that align with the pins 138 in the flange to align the frame when the fasteners 144 are removed. As shown in FIG. 17, when the fasteners 144 are released from the side wall 136, the entire roof can be removed, with the system 40 remaining installed on the roof 22. The roof 22 can be removed from the vehicle without having to disconnect any element of the system 40 from the component of the roof or vehicle to which it is fastened. In the case of the rear mounting arrangement, this means that the internal transfer means 44 and the external support mount 48 are attached to the roof via fastener 146 that connects them together and to the roof 22.

When the system is installed, as shown in FIG. 16, with a roof rack installed, the roof rack cross bars 76b, 76c transfer weight through the feet 74 into the external support mount 48, which transfers it through fastener 146 to the internal frame via plate 148 to the columns 154. The columns 154 transfer the load down to the cross beam 156 that spreads the load over the rear wall 136 of the vehicle body.

The system 40 is such that none of ate additional hardware over the original hardware provided for the hard top by the vehicle manufacturer needs to he removed in order to remove the hard top. The front internal transfer means is affixed to the vehicle frame and can remain in place. The front and rear external support mounts and the rear internal transfer means are secured to the hard top roof 22, so that the roof can be removed, without having to disconnect any of the elements of the system 40 from the roof or the vehicle frame.

Another advantage of the present invention is that with the system fully installed, as shown best in FIG. 2, two unobstructed areas 164 are provided between the roof rack rails 76. The areas 164 allow for the insertion of fork lift tines underneath a load, such as a pallet that is placed on the roof rack. This makes the loading and unloading, of the roof rack with a forklift available, which many previous known systems do not allow. The ability of the system 40 to transfer the load to the vehicle frame or body, allows for it to carry in excess of 100 kg, which makes the system suitable for tradesmen who would potentially take delivery of pallets of material.

The present invention provides a roof rack mounting and weight transfer system that allows for easy removal of the hard top roof and allows for the carrying of payload in excess of 100 kg.

It will be understood that the invention disclosed and defined in this specification extends to all alternative combinations of two or more of the individual features mentioned or evident from the text or drawings. All of these different combinations constitute various alternative aspects of the invention.

1. A roof rack mounting and weight transfer system for vehicles with removable hard tops, the system including:
at least two mounting arrangements, each mounting arrangement including:
an external support mount that is secured to the external surface of the roof for attaching a roof rack to; and
internal transfer means to transfer the load from the support mount to the vehicle body or frame.

2. A roof rack mounting and weight transfer system according to claim 1, wherein the system is such that the hard top can be removed without having to disconnect any element of the system from the component of the roof or vehicle to which it is fastened.

3. A roof rack mounting and weight transfer system according to claim 1, wherein, when the system is installed, the hard top can be removed without having to remove any hardware additional to the original hardware provided for the hard top by the vehicle manufacturer.

4. A roof rack mounting and weight transfer system according to claim 1, wherein the freedom panel can be removed whilst the roof rack is in use.

5. A roof rack mounting and weight transfer system according to claim 1, including a pair of front mounting arrangements and a pair of rear mounting arrangements.

6. A roof rack mounting and weight transfer system according to claim 5, wherein the from mounting arrangements are positioned to transfer load through the frame of the vehicle.

7. A roof rack mounting and weight transfer system according to claim 6, wherein the from mounting arrangements' internal transfer means includes a weight transfer bracket that is attached to the vehicle's frame.

8. A roof rack mounting and weight transfer system according to claim 7, wherein the rear mounting arrangements' internal transfer means includes an internal frame including at least two columns that transfer load down to the vehicle body.

9. A roof rack mounting and weight transfer system according to claim 1, wherein the external support mounts have an internal surface that matches the external profile of the roof or hard top.

10. A roof rack mounting and weight transfer system according to claim 9, wherein the external support mounts sit on top of the roof or hard top with a bottom edge in the roof channel of the vehicle, allowing the support mounts' upper surface to self level.

11. A roof rack mounting and weight transfer system according to claim 1, wherein the roof rack installed with the mounting system increases the carrying capacity of the removable hard top to in excess of 100 kg.

12. A roof rack mounting and weight transfer system for vehicles, the system including:
at least two front mounting arrangements and at least two rear mounting arrangements, each mounting arrangement including:
an external support mount that is secured to the external surface of the roof for attaching a roof rack foot to; and
internal transfer means to transfer the load from the support mount to the vehicle body or frame;
wherein the external support mounts are such that between installed roof rack rails running across the roof, an unobstructed area is provide on top of the hard top such that the tines of a fork lift can be inserted to a place a load onto the roof rack or to remove a load off the roof rack.

13. A roof rack mounting and. weight transfer system according to claim 12, wherein the system is such that the hard top can be removed without having to disconnect any element of the system from the component of the roof or vehicle to which it is fastened.

14. A roof rack mounting and weight transfer system according to claim 12, wherein, when the system is installed, the hard top can be removed without having to remove any hardware additional to the original hardware provide for the hard top b the vehicle manufacturer.

15. A roof rack mounting and weight transfer system according, to claim 12, wherein the freedom panel can be removed whilst the roof rack is in use.

16. A roof rack mounting and weight transfer system according to claim 12, the system including a pair of front mounting arrangements and a pair of rear mounting arrangements.

17. A roof rack mounting and weight transfer system according to claim 16, wherein the front mounting arrangements are positioned to transfer load through the frame of the vehicle.

18. A roof rack mounting and weight transfer system according to claim 17, wherein the front mounting arrangements' internal transfer means includes a weight transfer bracket that is attached to the vehicle's frame.

19. A roof rack mounting and weight transfer system according to claim 16, wherein the rear mounting arrangements' internal transfer means includes an internal frame including at least two columns that transfer load down to the vehicle body.

20. A roof rack mounting and weight transfer system according to claim 12, wherein the external support mounts have an internal surface that matches the external profile of the roof or hard top, and sits on top of the roof or hard top with the bottom edge in the roof channel, allowing the support mounts' upper surface to self level.
